(19) United States
(12) Patent Application Publication
(10) Pub. No.: US 2013/0015095 A1
(43) Pub. Date: Jan. 17, 2013

(54) ADMINISTRATION METHODS AND PACKAGINGS FOR DOSAGE UNITS

(71) Applicants: Bradley Carson, Ottawa Hills, OH (US); Mitchell Mosbacher, Maumee, OH (US); Robert E. Napierala, II, Sylvania, OH (US)

(72) Inventors: Bradley Carson, Ottawa Hills, OH (US); Mitchell Mosbacher, Maumee, OH (US); Robert E. Napierala, II, Sylvania, OH (US)

(73) Assignee: OMNICARE INC., Covington, KY (US)

(21) Appl. No.: 13/182,742

(22) Filed: Jul. 14, 2011

(51) Int. Cl. A61J 1/03; B65G 59/00; B65D 85/00

(52) U.S. Cl. 206/533; 206/459.5; 221/1

(57) ABSTRACT

Packagings for holding dosage units and methods for administering dosage units from a packaging. The packaging includes a cover and a body with compartments each configured to hold at least one of the dosage units. The compartments have a circular arrangement on the body. The packaging further includes a cover with a plurality of strips attached to the body for confining the dosage units in the compartments. Each of the strips is positioned relative to a respective one of the compartments and configured to be individually manipulated for releasing the dosage unit from the respective one of the compartments. The method includes manipulating one of the strips to unblock an opening to one of the compartments and removing the dosage unit from the compartment through the unblocked opening.

### CROSS-REFERENCE TO RELATED APPLICATIONS

This application is related to application Ser. No. 13/153,900, filed Jun. 6, 2011, which is hereby incorporated by reference herein in its entirety for all purposes.

### BACKGROUND

The invention relates generally to packagings for dosage units, such as oral medications, and methods for administering dosage units from a packaging to a patient.

Certain prescribed oral medications are administered to a patient on an “as needed” or “pro re nata” (PRN) basis according to a prescribed dosing regimen established by written parameters from a medical practitioner. For example, the written parameters may include the reason for administration, and the time or frequencies at which to administer the medication. Dosages of PRN oral medications are not scheduled for administration at certain times of the day or at regular hourly intervals. Administration of PRN oral medications is at the discretion of the caregiver or the patient. Conventional drug containers are commonly used to store the PRN oral medications until use.

Improved packagings and administration methods for dosage units, such as PRN oral medications, are needed that can improve prescription compliance.

### BRIEF SUMMARY

In an embodiment of the invention, a packaging is provided for holding a plurality of dosage units. The packaging includes a body including a plurality of compartments each configured to hold at least one of the dosage units. The compartments have a circular arrangement relative to a reference point on the body. The packaging further includes a cover with a plurality of strips attached to the body for confining the dosage units in the compartments. Each of the strips is positioned relative to a respective one of the compartments and configured to be individually manipulated for releasing the dosage unit from the respective one of the compartments.

In another embodiment of the invention, a method is provided for administering a plurality of dosage units from a packaging having a body with a plurality of compartments and a cover attached to the body. The cover is divided into a plurality of strips each confining at least one of the dosage units in one of the compartments. The method includes manipulating one of the strips to unblock an opening to one of the compartments and removing the dosage unit from the compartment through the unblocked opening.

### BRIEF DESCRIPTION OF THE SEVERAL VIEWS OF THE DRAWINGS

The accompanying drawings, which are incorporated in and constitute a part of this specification, illustrate various embodiments of the invention and, together with a general description of the invention given above and the detailed description of the embodiments given below, serve to explain the embodiments of the invention.

FIG. 1 is an exploded top perspective view of a packaging in accordance with an embodiment of the invention.

FIG. 1A is a perspective view of one of the compartments of the packaging shown in FIG. 1.

FIG. 1B is a top view of the body of the packaging of FIG. 1.

FIG. 1C is a top view similar to FIG. 1B for a body of the packaging in accordance with an alternative embodiment of the invention.

FIG. 2 is an exploded bottom perspective view of the packaging of FIG. 1.

FIG. 3 is a top view of the cover for the packaging shown in FIGS. 1 and 2 in which the outer surface is visible.

FIG. 3A is an enlarged view of a portion of FIG. 3.

FIG. 4 is a bottom view of the cover of FIG. 3 in which the inner surface that contacts the body is visible.

FIG. 4A is a cross-sectional view taken generally along line 4A-4A in FIG. 4.

FIG. 4B is an enlarged view of a portion of FIG. 4.

FIG. 5 is a top perspective view similar to FIG. 1 in which the cover and body of the packaging are attached together.

FIG. 6 is a bottom perspective view similar to FIG. 2 in which the cover and body of the packaging are attached together.

FIG. 7 is a top perspective view of the packaging after the oral medications are placed into the compartments and the cover is attached to form a package.

FIG. 8 is a top perspective view of the package of FIG. 7 illustrating the peeling of one of the strips to expose an opening to one of the compartments for removal of the corresponding oral medication from the compartment.

FIG. 9 is a bottom view similar to FIG. 4 of a cover constructed in accordance with an alternative embodiment of the invention in which the number of strips is reduced.

### DETAILED DESCRIPTION

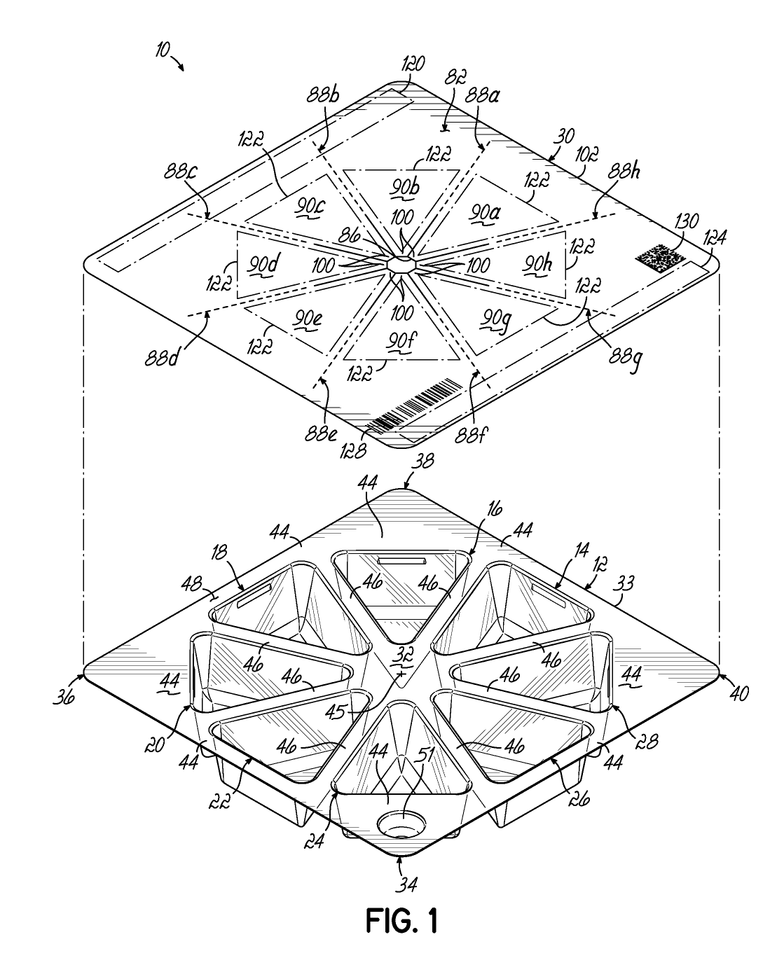

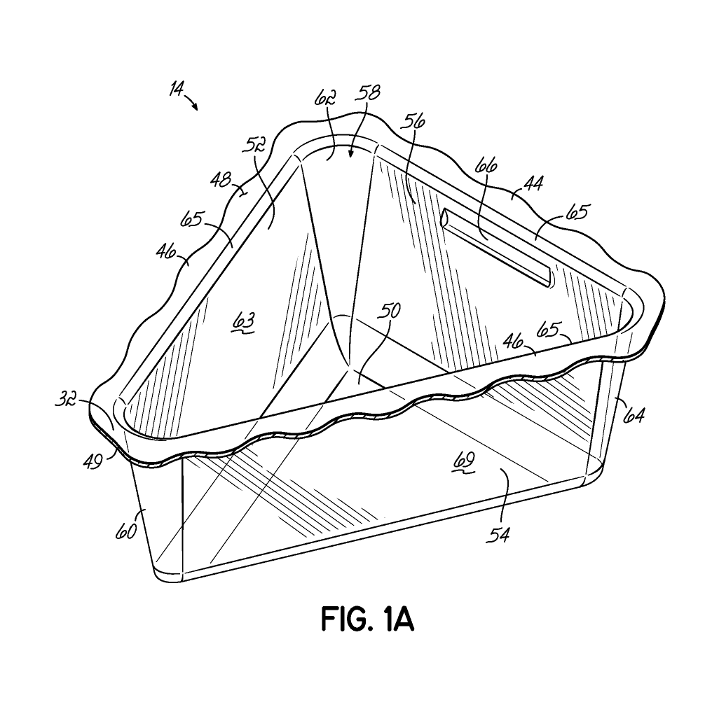

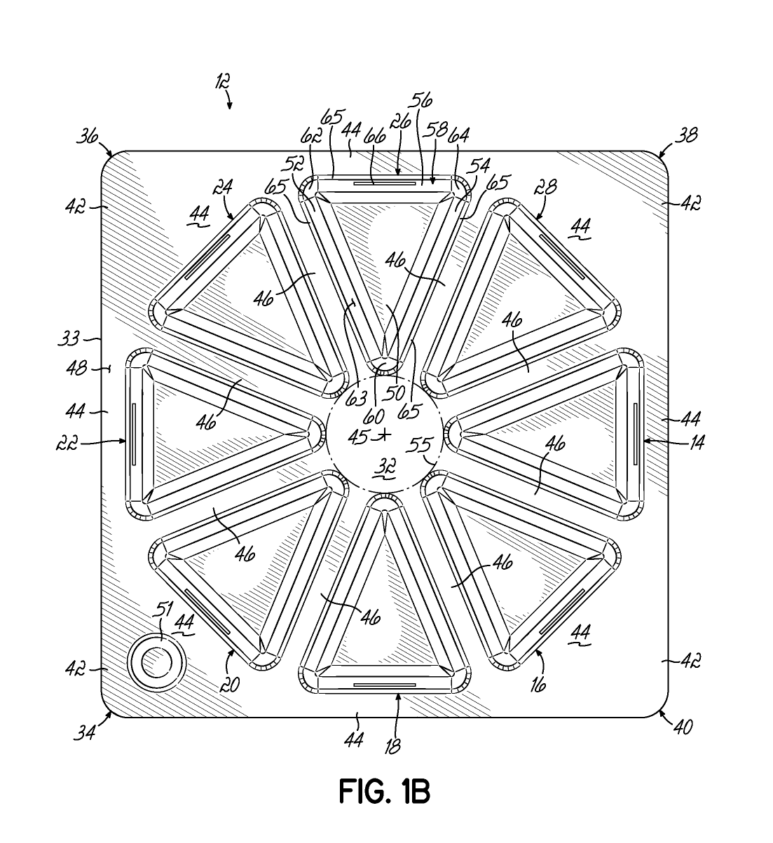

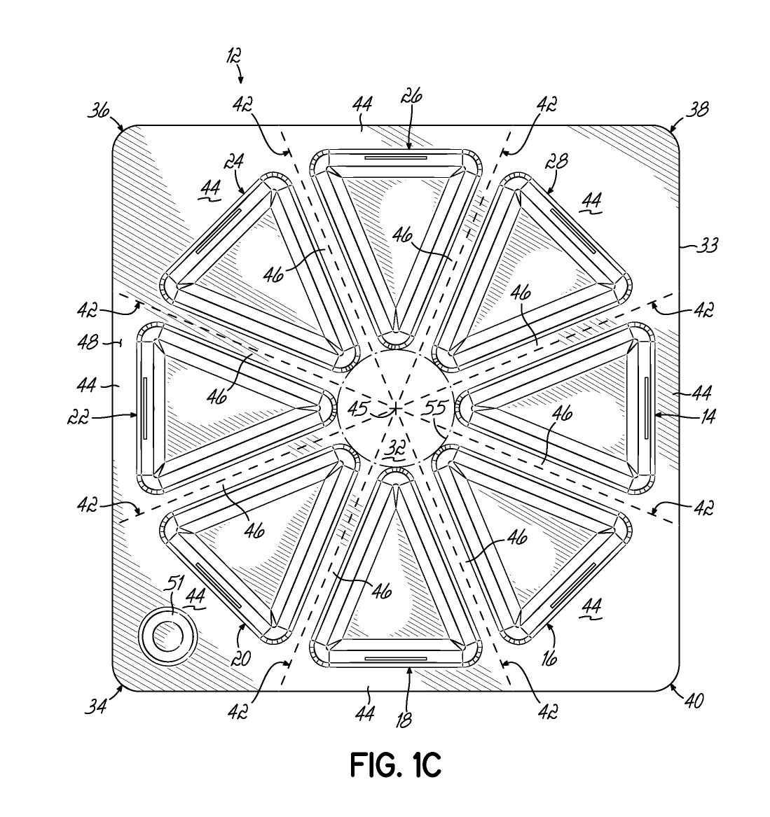

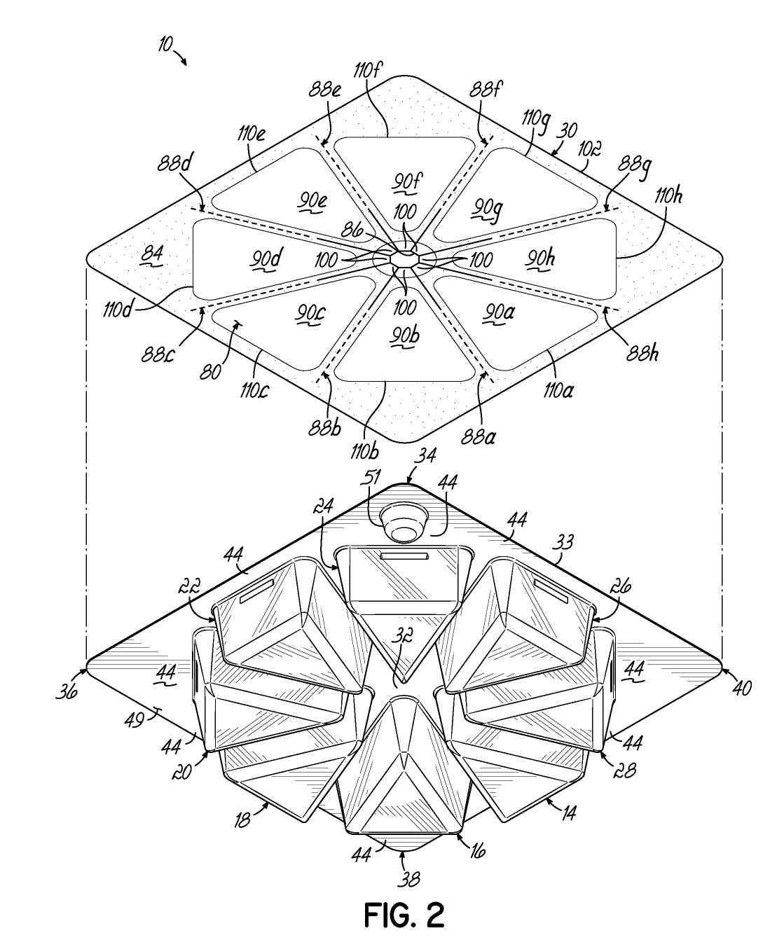

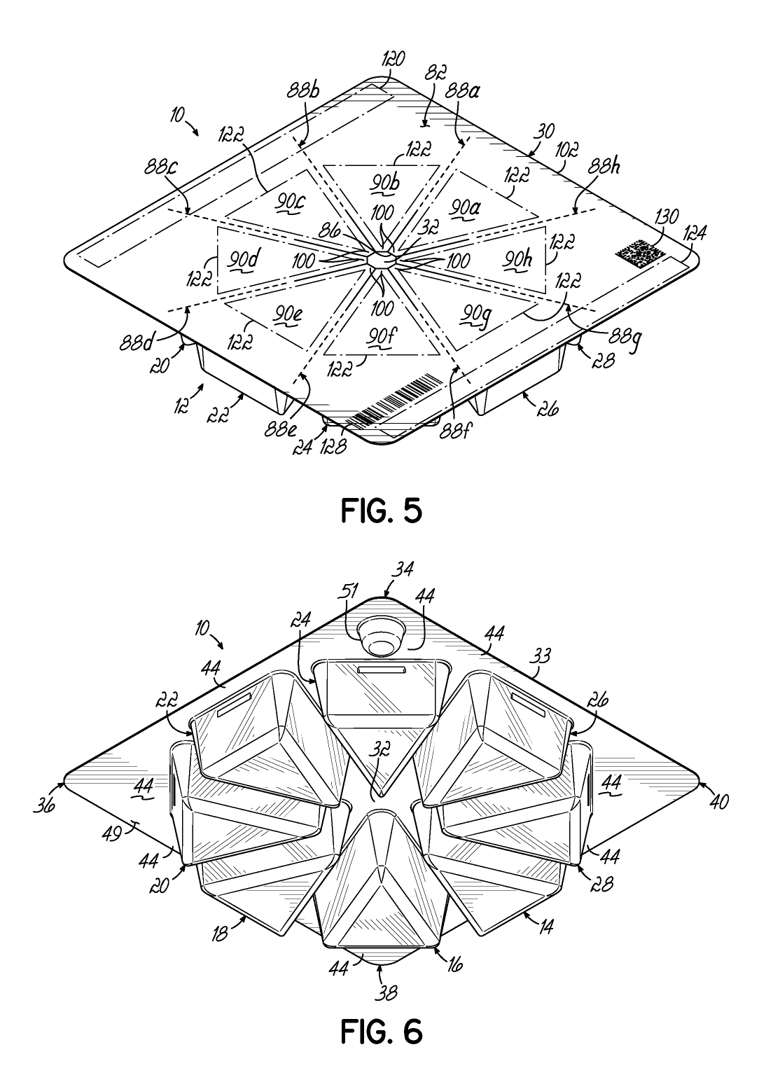

With reference to FIGS. 1, 1B, and 2 and in accordance with an embodiment of the invention, an oral medication packaging 10 includes a body 12 with a plurality of cavities or compartments 14, 16, 18, 20, 22, 24, 26, 28 and a lidding sheet in the form of a cover 30. The cover 30 is joined to the body 12 in order to seal closed the compartments 14, 16, 18, 20, 22, 24, 26, 28. In the representative embodiment, the number of compartments 14, 16, 18, 20, 22, 24, 26, 28 is eight. Each of the compartments 14, 16, 18, 20, 22, 24, 26, 28 may be configured to receive and hold dosage units, each of which in the representative embodiment is a unit dose of an oral medication 25 (i.e., when the unit dose is a full dosage or a half dosage) or a portion of a unit dose of an oral medication 25 (i.e., when the unit dose includes multiple dosages). During filling, oral medications 25 are placed into one or more of the compartments 14, 16, 18, 20, 22, 24, 26, 28 and the cover 30 is attached to the body 12 to form the packaging 10. In one embodiment, the oral medications may be placed into fewer than all of the compartments 14, 16, 18, 20, 22, 24, 26, 28. The assembly (FIGS. 5 and 6) including the body 12, cover 30, and oral medications 25 comprises a package that is sealed to prevent the ingress of environmental contaminants and that is in a state prepared for subsequent distribution to a patient.

Each of the oral medications 25 may be any type of ingestible substance capable of being categorized as an oral medication and classified as a PRN medication. The ingestible substance comprising each of the oral medications 25 may include, but is not limited to, a pharmaceutical, a medicament, a composition, or a drug, either alone or in combination that alters the physiology of the patient and that may be dispensed by prescription or over-the-counter. A PRN medication is a medication that is prescribed and administered “as needed”. Common PRN oral medications include, but are not limited to, nonsteroidal anti-inflammatory drugs, analgesics, narcotics, tranquilizers, hypnotics, antiemetics, antipsychotics, laxatives, sleeping aids, respiratory tract drugs, and gastrointestinal tract drugs. The oral medications 25 are sized to fit into the compartments 14, 16, 18, 20, 22, 24, 26, 28. A unit dose is an amount of the ingestible substance that is administered to a patient in a single dose. The oral medications 25 may be provided in various dosage forms such as pills, tablets, capsules, gel capsules, solids, lozenges, vials, ampoules, liquids, powders, etc. One or more of the oral medication 25 may be a unit dose that is packaged inside an individual blister package that is then placed into the packaging 10.

The compartments 14, 16, 18, 20, 22, 24, 26, 28 are organized as a series of cavities arranged about a central region 32 of the body 12 that in the representative embodiment are triangular in cross-section (i.e., wedge-shaped). The compartments 14, 16, 18, 20, 22, 24, 26, 28 are displaced in a radial direction slightly outward from central region 32 toward an outer perimeter 33 of the body 12. The body 12 includes a plurality of corners 34, 36, 38, 40. The compartments 14, 16, 18, 20, 22, 24, 26, 28 are encircled by a polygonal shoulder 44, which is inscribed inside the outer perimeter 33 of body 12. Lands or strips 46, which extend radially from the central region 32 to the shoulder 44, are present between adjacent pairs of the compartments 14, 16, 18, 20, 22, 24, 26, 28. A centerline of each of the strips 46, if extended to reach a center 45 of the central region 32, may intersect at the center 45. The shoulder 44 is disposed between the compartments 14, 16, 18, 20, 22, 24, 26, 28 and the outer perimeter 33 of the body 12. The corners 34, 36, 38, 40 are disposed between shoulder 44 and the outer perimeter 33 of the body 12. The surfaces of the central region 32, shoulder 44, and strips 46 are disposed in a common plane collectively defining an outer surface 48 of the body 12.

The body 12 of the packaging 10 includes an inner surface 49 that is opposite to the outer surface 48 and that mirrors the outer surface 48. The surfaces 48, 49 converge at an edge extending about the outer perimeter 33 of the body 12. The distance between the surfaces 48, 49 defines the thickness of the body 12, which is selected to lend a targeted degree of rigidity or semi-rigidity to the body 12.

As best shown in FIG. 1B, the compartments 14, 16, 18, 20, 22, 24, 26, 28 have a circular arrangement of positions or locations on the body 12 and are arranged about the circumference of a reference circle 55. Specifically, a reference point on each of the compartments 14, 16, 18, 20, 22, 24, 26, 28 or arc associated with each of the compartments 14, 16, 18, 20, 22, 24, 26, 28 may be arranged on the circumference of the reference circle 55. A center of the reference circle 55 may coincide with the center 45 of central region 32 or, alternatively, with another point in central region 32 of the body 12. The reference point or arc may be a nominally equivalent location on each of the compartments 14, 16, 18, 20, 22, 24, 26, 28. In the representative embodiment, the reference point on the reference circle 55 for each of the compartments 14, 16, 18, 20, 22, 24, 26, 28 is a respective position where the corner 60 (FIG. 1A) intersects the edge 65 (FIG. 1A) so that all corners 60 are equidistantly spaced from the center of the reference circle 55 with the same radius. However, other alternative reference arcs or points (e.g., the centroid to the opening 58 (FIG. 1A) associated with each of the compartments 14, 16, 18, 20, 22, 24, 26, 28) may be selected such that the diameter of the reference circle 55 is increased. One or more of the compartments 14, 16, 18, 20, 22, 24, 26, 28 may have a different radial location relative to the center of the reference circle 55 so long as the circular arrangement is maintained.

Generally, the reference circle 55 characterizing the circular arrangement may be divided into a plurality of sectors. Each of the compartments 14, 16, 18, 20, 22, 24, 26, 28 may be located within a unique sector characterized by a central angle having the center of the reference circle 55 as a vertex. The sides bounding the central angle for each of the compartments 14, 16, 18, 20, 22, 24, 26, 28 may extend through an adjacent pair of the strips 46. In one embodiment, the central angle for each of the unique sectors may be equal (e.g., 45°) so that the compartments 14, 16, 18, 20, 22, 24, 26, 28 are uniformly spaced and distributed in the circular arrangement.

From a perspective normal to the surface 48, the outer perimeter 33 of the body 12 may have a rectangular geometrical shape or, in a specific embodiment, may be square with side edges at the outer perimeter 33 of approximately equal length. In one embodiment, the body 12 may have a square geometrical shape with side edges measuring approximately 4 inches in length. This compact sizing permits the patient or caregiver to conveniently insert the assembled and filled packaging 10 into most shirt or blouse pockets.

The body 12 of the packaging 10 may include an indexing feature 51 in the representative form of a blind, hollow post that is disposed in the vicinity of corner 34 in the representative embodiment. Alternatively, the indexing feature 51 may be located in one of the other corners 36, 38, 40. The indexing feature 51 projects away from the plane of surface 48 in the same direction as the compartments 14, 16, 18, 20, 22, 24, 26, 28. The indexing feature 51 may be utilized to rotationally orient the body 12, for example, relative to tooling used to hold the packaging 10 for filling with the oral medications 25. As a specific example, the body 12 of series of packages 10 may be rotationally oriented such that the compartment 14 is consistently positioned at a known location. In this manner, the angular orientation of multiple different packagings 10 can be reproducibly established for positioning the compartments 14, 16, 18, 20, 22, 24, 26, 28 at known and fixed positions during a filling operation.

As best shown in FIG. 1A, the compartment 14, which is representative of the compartments 14, 16, 18, 20, 22, 24, 26, 28, includes a bottom wall 50 and side walls 52, 54, 56 that project from the surface 48 toward the bottom wall 50. Side wall 52 physically joins or connects with side wall 54 at a corner 60, side wall 56 physically joins or connects with side wall 52 at a corner 62, and side wall 56 physically joins or connects with side wall 54 at a corner 64. Similarly, the side walls 52, 54, 56 join the bottom wall 50 along respective corners. Side walls 52, 54 extend parallel to the strips 46 toward the outer perimeter 33 of the body 12. Side wall 52 and side wall 54 may have approximately equal lengths and each of the side walls 52, 54 may be longer than side wall 56.

The bottom wall 50 and side walls 52, 54, 56 of the compartment 14 have an interior surface 63 that contacts the oral medication 25 placed into compartment 14 and an exterior surface 69 separated from the oral medication 25 by the thickness of the walls 50, 52, 54, 56. The interior surface 63, which joins surface 48 at an edge 65, is continuous across the edge 65 with surface 48. Edge 65 is bounded by the central region 32 on the inner radius relative to center 45 and the shoulder 44 on the outer radius, and is circumferentially bounded by an adjacent pair of strips 46. The exterior surface 69, which joins surface 49, is continuous with surface 49. The interior surface 63 of compartment 14 is recessed relative to the plane of surface 48 and the exterior surface 69 of compartment 14 projects away from the plane of surface 49.

The corners 60, 62, 64 are inside corners on interior surface 63 and outside corners on exterior surface 69. Corner 60 is located closer to the central region 32 than corners 62, 64. Corner 60 is separated from corner 62 by the length of the side wall 52 and is separated from corner 64 by the length of the side wall 54. Corners 62, 64 are located more proximate to the outer perimeter 33 than corner 60 and are nominally distanced by the length of the side walls 54, 56 from corner 60. Corner 60 is characterized by an included or interior angle between the side walls 52, 54 of, for example, 45°. The interior or included angles of the other corners 62, 64 may be approximately equal. When viewed from a perspective normal to the bottom wall 50, the side walls 52, 54, 56 of the compartment 14 have a triangular arrangement and the opening 58 is characterized by a triangular geometrical shape.

The open space inside the walls 50, 52, 54, 56 is accessed through an opening 58 defined in the plane of surface 48 and peripherally bounded by edge 65. The oral medications 25 are inserted and removed from the body 12 through the openings 58. The opening 58 has a cross-sectional area assessed in the plane of surface 48 and the bottom wall 50 has a surface area that is slightly smaller than the cross-sectional area of the opening 58. To accommodate the difference in areas, the corners 60, 62, 64 taper in width in a direction from surface 48 toward bottom wall 50.

The width of the compartment 14, which is measured as a distance or separation between the respective interior surfaces of the side walls 52, 54, narrows in a direction from corners 62, 64 toward the center 45 of the central region 32 with the minimum width occurring near the corner 60. In one embodiment, the width of the compartment 14 may monotonically decrease with increasing distance from corner 60. Compartment 14 includes a depth that is measured from the plane of surface 48 to the plane of the interior surface of the bottom wall 50. In one embodiment, the depth of the compartment 14 may be uniform across the surface area in the plane of the interior surface of the bottom wall 50. The depth and width of the compartment 14 are selected to receive and hold oral medications 25 of multiple different sizes and shapes. In various embodiments, the depth of the compartment 14 may range from thirteen (13) to seventeen (17) millimeters and the maximum width of the compartment 14 may range from twenty nine (29) millimeters to thirty three (33) millimeters.

Side wall 56 may include a denesting feature 66 represented by a small ridge that projects into the compartment 14 from side wall 56. Before use, the bodies 12 of multiple packagings 10 may be stacked with the compartments 14, 16, 18, 20, 22, 24, 26, 28 nested (i.e., fit inside each other). The denesting feature 66 functions to prevent the bodies 12 from tightly nesting so that they are difficult to separate and singulate from the stack. In one embodiment, the side wall 56 of each of the compartments 14, 16, 18, 20, 22, 24, 26, 28 may include the denesting feature 66. Alternatively, the denesting feature 66 may be provided on the side wall 56 of fewer than all of the compartments 14, 16, 18, 20, 22, 24, 26, 28. The denesting feature 66 is typically formed when the body 12 is formed and may represent a feature of the mold used to form body 12.

The body 12 of the packaging 10 may be formed from a thin sheet composed of a polymer, such as polyvinyl chloride (PVC). The polymer comprising the thin sheet may be opaque, translucent, or transparent with regard to light transmission. The sheet may be molded or otherwise processed in a conventional manner to produce the compartments 14, 16, 18, 20, 22, 24, 26, 28. For example, the body 12 may be fabricated by a thermoforming process in which a thin-gauge sheet of thermoplastic polymer is pre-heated to a pliable forming temperature, formed to the specific shape in a mold, cooled to regain its rigidity, and trimmed to shape. The thin-gauge sheet used in the thermoforming process to form body 12 may be supplied to the thermoforming process from a roll of stock material.

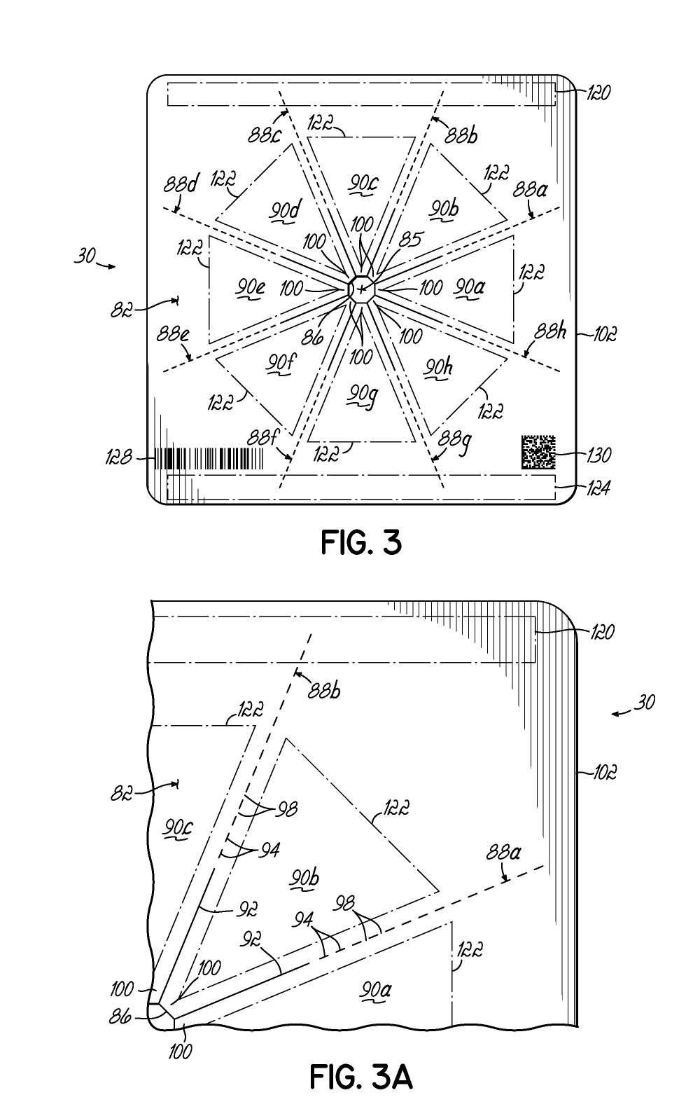

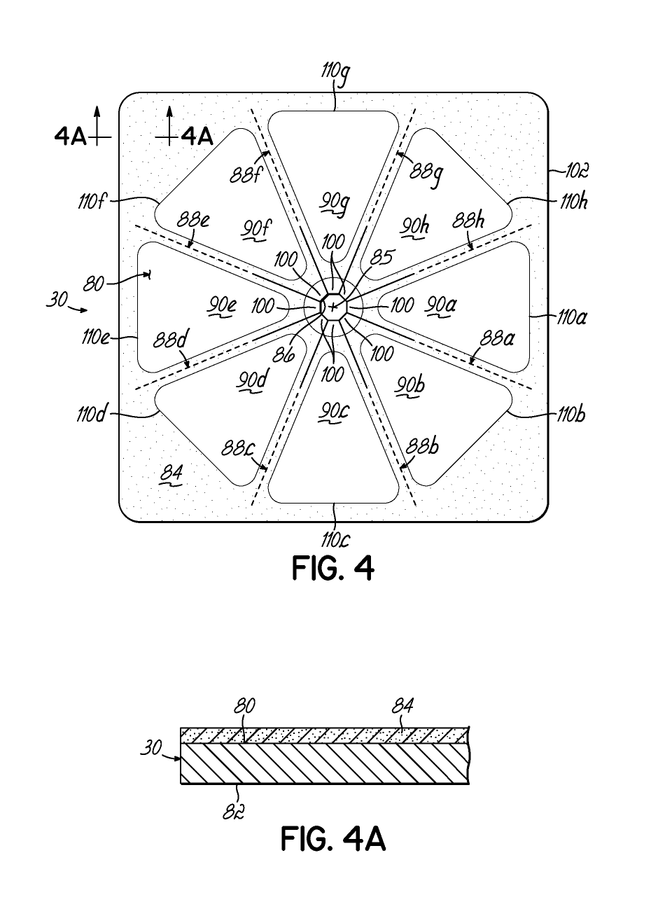

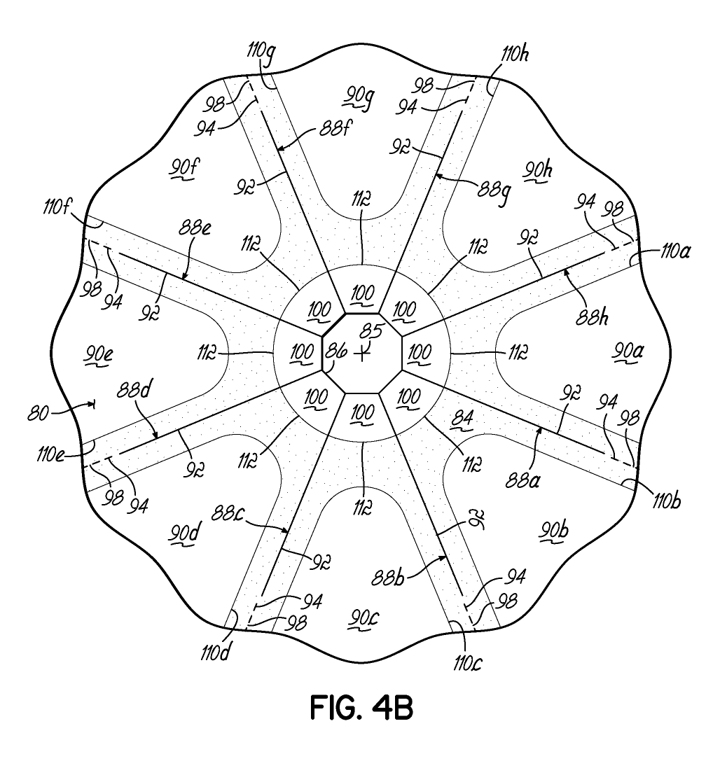

With reference to FIGS. 3, 3A, 4, 4A, and 4B, the cover 30 has approximately the same geometrical shape and dimensions as the body 12 of the packaging 10. The cover 30 has one surface 80 that is attached to the body 12 and a second surface 82 that is not attached to the body 12. In particular, surface 80 of the cover 30 is attached to the surface 48 of the body 12 to seal the compartments 14, 16, 18, 20, 22, 24, 26, 28 and to thereby seal the oral medications 25 in the compartments 14, 16, 18, 20, 22, 24, 26, 28. When the cover 30 is attached to the body 12, the side walls 52, 54, 56 project in a direction away from the surface 80 of the cover 30. When the packaging 10 is assembled (FIGS. 5 and 6), surface 82 is visible to an observer and exposed to environmental elements.

The cover 30 of the packaging 10 may be formed from a thin sheet comprised of a composite material, such as a blend of paper with a polymer, such as polypropylene. From a perspective normal to the surface 82, an outer perimeter 102 of the cover 30 may have a rectangular geometrical shape that matches the outer perimeter 33 of the body 12. In a specific embodiment, the outer perimeter 102 of the cover 30 may be square with side edges at the outer perimeter 33 of approximately equal length. Typically, the cover 30 is opaque to provide contrast for information in data fields 120, 122, 124, but may also be translucent or transparent with regard to light transmission.

Surface 80 of cover 30 may include a coating 84, as best shown in FIG. 4A, that is used to releasably attach the cover 30 to the shoulder 44, strips 46, and central region 32 of the body 12. Surface 82 of the cover 30 is separated from the coating 84 on surface 80 by the thickness of the cover 30. The second surface 82 is nominally free of the substance in the coating 84, other than negligible amounts of stray residue that may be present as a result of the application process applying the coating 84 to surface 80. Among other variables, the width of shoulder 44, the width of strips 46, and the area of central region 32 in the plane of surface 48 may be adjusted to set a level of adhesion and thereby set the resistance against removal of cover 30.

The cover 30 includes an opening 86, a plurality of score or tear lines 88a-h that radiate outwardly from the opening 86, and a plurality of strips 90a-h that are individually removable from the body 12. In the representative embodiment, the strips 90a-h are roughly triangular in shape. The opening 86 extends from surface 80 to surface 82 and may be created in the cover 30 by punching and removing a portion of the cover 30. The opening 86 defines an inner edge that encircles a reference point 85, which may be the center of the cover 30. A portion of the central region 32 of the body 12 is exposed through the opening 86. The opening 86 may have any of a wide variety of shapes and may be slightly scalloped because the tips of the strips 90a-h may not be curved. In the representative embodiment, the opening 86 is centered on the geometrical center of the cover 30 and has an octagonal shape because the tips of the strips 90a-h are flat.

With continued reference to FIGS. 3, 3A, 4, 4A, and 4B, the tear lines 88a-h divide or partition the majority of the cover 30 into the strips 90a-h. Each of the strips 90a-h is spatially correlated with one of the compartments 14, 16, 18, 20, 22, 24, 26, 28 and occludes the corresponding opening 58 to confine the corresponding oral medication 25 therein. The strips 90a-h have approximately the same planar geometrical shape (e.g., triangular) as the compartment openings 58 and have approximately the same circular arrangement as the compartments 14, 16, 18, 20, 22, 24, 26, 28. A relatively narrow tip of each strip 90a-h is located proximate to the reference point 85. Each strip 90a-h widens as the outer perimeter 102 of the cover 30 is approached or, equivalently, with increasing distance from the reference point 85. Each circumferentially adjacent pair of tear lines 88a-h borders one of the strips 90a-h and one of the tear lines 88a-h is disposed between each adjacent pair of strips 90a-h.

Each tear line 88a-h includes a perforation or slit 92 and a line of perforations or slits 94 that is collinearly aligned with the slit 92. Each slit 92 is located nearer to the reference point 85 of the cover 30 than the corresponding set of slits 94 and slit 92 is disposed between the reference point 85 and the slits 94. Each of the slits 94 has a different length than the slit 92 and, in particular, each of the slits 94 is shorter in length than the slit 92. Each slit 92 and the slits 94 may be cut to extend through the entire thickness of the cover 30 or, alternatively, may be cut to only extend partially through the thickness of the cover 30. Adjacent pairs of the slits 94 of each tear line 88a-h are lengthwise separated by a respective one of a plurality of lands 98, as best shown in FIG. 3A. In each tear line 88a-h, one of the lands 98 is disposed between the slit 92 and the slit 94 that is the nearest neighbor of slit 92. The slits 94 may be characterized by a wide variety of lengths and cut-to-land ratios. In various embodiments, slit 92 may have a length between 10.0 mm and 30.0 mm, each slit 94 may have a length between 0.5 mm and 3.0 mm, and the cut-to-land ratio of the slits 94 can range from 0.5:1 to 3:1. In an alternative embodiment, each tear line 88a-h may include more than one slit 94.

Each tear line 88a-h in the cover 30 is aligned generally with one of the strips 46 of the body 12 and extends radially outward from the reference point 85. The separation between adjacent pairs of the tear lines 88a-h increases with increasing distance from the edge of the opening 86. Each tear line 88a-h partitions one of the strips 90a-h into first and second portions of surface 80 that contact surface 48. The first portion of each partitioned strip 90a-h is attached to surface 48 on one side of the respective tear line 88a-h and the second portion of each partitioned strip 90a-h is attached to surface 48 on an opposite side of the respective tear line 88. The partitioning of each of the strips 90a-h into first and second portions permits each of the strips 90a-h to be at least partially removed while adjacent flanking strips 90a-h remain essentially undisturbed and attached to the body 12. Each tear line 88a-h may have a length that extends in a radial direction parallel to the respective strip 46 of body 12 for a length that exceeds the length of the side walls 52, 54.

Each slit 92 intersects the opening 86 and, as a result, a pull tab 100 is defined by a portion of each of the strips 90a-h between each adjacent pair of slits 92. The coating 84 is applied so that the pull tab 100 is not adhered to the body 12. Each pull tab 100 can be lifted relative to the body 12 with a fingernail or with an object or the assistance of an object, such as a piece of flatware (e.g., knife) or a nail file. Once lifted, each pull tab 100 can be manipulated by movement toward an outer perimeter 102 of the cover 30 and the outer perimeter 33 of the body 12 for removing one of the strips 90a-h. The slits 94 halt short of reaching the outer perimeter 102 of the cover 30 so that the peeling of the strips 90a-h typically does not encroach into the region where the cover 30 is attached to the shoulder 44.

The shape, design, angle, and/or style of the tear lines 88a-h may differ from the construction shown in the representative embodiment. Design factors, such as the composition and thickness of the material used to fabricate the cover 30, may influence the properties of the slits 92, 94 such as cut-to-land ratio, the use of parallel lines of perforations for the slits 92, 94, the use of micro-perforations or dots, etc., in order to ensure each of the strips 90a-h can be cleanly removed to expose the entrance opening to the respective compartment without exposing the entrance opening to adjacent compartments. The peeling of each of the strips 90a-h may or may not tear along the corresponding tear lines 88a-h, and one or both of the tears may deviate from constraint along the path of the tear lines 88a-h and instead propagate through a portion of the strip 90a-h. The strips 90a-h are typically removed from the cover 30 by the peeling process.

As best shown in FIG. 3, the strips 90a-h have a circular arrangement of positions or locations on the cover 30 and are arranged about the circumference of a reference circle coincident with the inner edge of opening 86. Specifically, a reference point on each of the strips 90a-h or arc associated with each of the strips 90a-h may be arranged on the circumference of the reference circle. In the representative embodiment, the reference point on the reference circle for each of the strips 90a-h can be considered to be the tip of each pull tab 100 adjacent to the reference point 85 on the cover 30 about which the strips 90a-h are centered.

The strips 90a-h are arranged as pie-shaped sectors with each sector defined between an adjacent pair of the tear lines 88a-h, which represent segments originating at the center (i.e., reference point 85) of the reference circle. In one embodiment, the central angle for each of the sectors may be equal (e.g., 45°) so that the strips 90a-h are uniformly spaced and distributed circumferentially in the circular arrangement. The sectors containing the strips 90a-h are slightly wider than the sectors containing the compartments 14, 16, 18, 20, 22, 24, 26, 28 because of the need to provide a seal mediated by coating 84 with the strips 46 of the body 12. The pull tab 100 of each strip 90a-h is located proximate to the corner 60 between sidewalls 52, 54 so that the narrow portion of each strip 90a-h is near the narrow portion of the compartment opening 58. In the matching triangular shapes of the representative embodiment, the widening of each strip 90a-h matches the widening of the separation of the sidewalls 52, 54 so that each compartment opening 58 is inscribed between an adjacent pair of the tear lines 88a-h.

Each of the strips 90a-h is positioned on the cover 30 to obstruct or occlude the opening 58 of one of the compartments 14, 16, 18, 20, 22, 24, 26, 28 so that each opening 58 is blocked by a barrier and the oral medication 25 cannot be released through the opening 58 absent strip removal. Each of the strips 90a-h is configured to be individually manipulated using its pull tab 100 for releasing the oral medication 25 from the respective one of the compartments 14, 16, 18, 20, 22, 24, 26, 28. The manipulation applies a force that overcomes the attachment (e.g., adhesive force) provided by the coating 84 between the body 12 and each of the strips 90a-h. The ability to individually and sequentially remove each of the strips 90a-h independent of the other strips 90a-h permits each oral medication 25 to be freed or released for administration as a PRN oral medication. In particular, the removal of one of the strips 90a-h uncovers the opening 58 to one of the compartments 14, 16, 18, 20, 22, 24, 26, 28 by removing the obstruction and permits manipulation of the body 12 (e.g., partial or total inversion) to liberate the oral medication 25 from its confinement in the packaging 10.

The cover 30 may be formed from roll stock to which the coating 84 is an adhesive (e.g., pressure sensitive adhesive) pre-applied as a coating across the full surface area of surface 80. In one embodiment, the roll stock may be label stock with the coating 84 and a removable liner (not shown) covering the coating 84. In one embodiment, the cover 30 may be formed by die cutting the roll stock and the tear lines 88a-h may be formed when each cover 30 is die cut.

In one embodiment, the coating 84 may be comprised of a pressure sensitive adhesive that is permanently tacky and is typically used in conjunction with a release liner. Alternatively, the coating 84 may be comprised of a cold seal adhesive that only adheres to itself; however, this embodiment may also require coating the surface 48 of the body 12 with the same of a compatible cold seal adhesive to provide an adhesive bond with the cold seal adhesive residing on surface 80. In another alternative embodiment, the substance in the coating 84 on surface 80 may be a heat activated adhesive that must be heated for a defined period of time at an elevated temperature and/or in the presence of applied pressure in order to achieve final bonding strength.

The coating 84 may be modified to selectively reduce the adhesiveness of the constituent substance or material. Specifically, if the coating 84 is comprised of an adhesive, a deadening material, such as a varnish, may be applied (e.g., by printing) over the entire surface area of surface 80. The deadening material functions to adjust the adhesiveness of the coating 84 and therefore the adhesion of cover 30 to the surface 48 of body 12.

In the representative embodiment, the deadening material may be selectively patterned to form regions 110a-h in the coating 84 that match the geometrical shape (e.g., triangular shape) and pattern of the openings 58 to the compartments 14, 16, 18, 20, 22, 24, 26, 28 of the body 12. Each region 110a-h is circumferentially located between an adjacent pair of tear lines 88a-h so that each region 110a-h is physically disposed on one of the strips 90a-h. Each region 110a-h is radially located between the reference point 85 and opening 86 of the cover 30 and the outer perimeter 102 of the cover 30. In an alternative embodiment, the dispensing of the material constituting the coating 84 may be controlled such that the constituent material is selectively patterned so as to not be applied to surface 80 of cover 30 in regions 110a-h.

The regions 110a-h are modified by the deadening material so as to preferably exhibit either no or negligible adhesiveness upon contact with the medications 25. The regions 110a-h are also provided in a circular arrangement on a center that matches the circular arrangement of the compartments 14, 16, 18, 20, 22, 24, 26, 28. The coating 84 of the cover 30 therefore exhibits different levels of adhesiveness at different positions across the surface area of surface 82. When the cover 30 is joined to the body 12 (FIGS. 5, 6), each of the regions 110a-h is aligned spatially with the location of the opening 58 to one of the compartments 14, 16, 18, 20, 22, 24, 26, 28 of the body 12.

Alternatively, if a release liner is present on the label stock used to form the cover 30, the release liner may be die cut, while resident on the cover 30, to define sections of release liner that function as the regions 110a-h and have locations selectively correlated with the location of the openings 58 to the compartments 14, 16, 18, 20, 22, 24, 26, 28 of the body 12. In one embodiment, these sections of release liner would match the shape of the openings 58 and the arrangement of the compartments 14, 16, 18, 20, 22, 24, 26, 28 and therefore have an appearance similar or identical to regions 110a-h. In a representative embodiment, the sections of release liner may be patterned to have a triangular shape to match the triangular shape of regions 110a-h. The sections of release liner would eliminate any adhesion of the medications 25 with the coating 84. The sections of release liner serving as regions 1101-h remain adhered to the coating 84 on the cover 30 after the remainder of the release liner is removed to expose the coating 84 for attaching the cover 30 to the body 12. In use, each section of release liner is removed when the respective one of the strips 90a-h is removed.

As best shown in FIG. 4B, each of the strips 90a-h includes a region 112 in which the coating 84 has been modified so that the pull tab 100 has a reduced adhesion or negligible adhesion with the surface 48 of body 12. Each region 112 is located proximate to the reference point 85 and opening 86 in the cover 30. If the coating 84 is comprised of an adhesive, the regions 112 may be formed by the selective application of the deadening material, by patterning the application of the adhesive so that regions 112 are selectively free of adhesive, or by die cutting the release liner so that the coating 84 in each region 112 is selectively covered by a die-cut section of the release liner. The coating 84 is present in a narrow stripe between each of the regions 110a-h and the region 112 on the corresponding one of the strips 90a-h so that the cover 30 is sealed with the surface 48 near each of the corners 60.

Surface 82 of cover 30 may include information-containing data fields 120, 122, 124 and machine-readable markings 128, 130. The data fields 120, 122, 124 and machine-readable markings 128, 130 are customized to be specific to the patient to whom the oral medications 25 are prescribed and, hence, may contain information pertinent to the packaging 10, its contents of oral medications 25, and the patient.

Each of the data fields 120, 122, 124 may contain human-readable text such as simple text with any number and combination of alphanumeric characters, as well as optional symbols, grammatically formatted and arranged to be parsed and understood by a human reader and to convey information to the human reader. The machine-readable markings 128, 130 may comprise a one-dimensional bar code or a two-dimensional bar code containing a light background and dark informational elements arranged in a pattern on the light background. The data fields 120, 122, 124 and machine-readable markings 128, 130 may be printed using conventional printing techniques or otherwise applied onto the surface 82 of the cover 30. For example, the data fields may be directly printed with a conventional printer (e.g., label printer) onto the surface 82 before the cover 30 is assembled with the body 12.

The human-readable text in data field 120 may contain information relating to the patient, such as patient name, patient date of birth, patient sex, patient telephone number, residential street address of the patient, prescription number, and/or dispense date. This information may be used to verify that the named patient associated with the packaging 10 is correct. The human-readable text in data field 122 may contain information that relates to the oral medications 25 inside the packaging 10. Data field 122 is present on each of the strips 90a-h. The orientation, arrangement, and wording of lines of text in each data field 122 may be identical primarily because the same oral medication 25 is present in each of the compartments 14, 16, 18, 20, 22, 24, 26, 28. However, the text in the data field 122 on one or more of the strips 90a-h may differ if, for example, the corresponding one of the compartments 14, 16, 18, 20, 22, 24, 26, 28 is unfilled. The information in the data field 122 may include, but is not limited to, oral medication name, expiration date, lot number, the name of the pharmacy, and strength. The human-readable text in data field 124 may contain information relating to the pharmacy or facility that filled the package 10. The areas occupied by the data fields

The machine-readable markings 128, 130 may encode information selected from one or more of the data fields 120, 122, 124. The machine-readable markings 128, 130 may be utilized by a machine, such as a smartphone, a vision system, or a bar code reader, equipped with suitable electronics capable of reading, imaging, or scanning the machine-readable markings 128, 130 and translating the resulting data into a digital form that is usable by the machine to track and/or verify each individual packaging 10.

With reference to FIGS. 5 and 6, the cover 30 is assembled with the body 12 to provide the packaging 10 that contains the oral medications 25 (FIG. 8). The attachment of the cover 30 to the body 12 occurs after the oral medications 25 are placed in the compartments 14, 16, 18, 20, 22, 24, 26, 28. The assembly securely holds the oral medications 25 for distribution to a patient and stores the oral medications 25 until administered to the patient.

With reference to FIG. 1C in which like reference numerals refer to like features in FIGS. 1-8 and in accordance with an alternative embodiment, the central region 32, strips 46, and shoulder 44 of the body 12 may be provided with tear lines 42. The locations of the tear lines 42 are spatially correlated with the locations of the tear lines 88a-h in the cover 30. The modification to the body 12 adding the tear lines 42 permits individual compartments 14, 16, 18, 20, 22, 24, 26, 28 to be severed from the body 12. The oral medication 25 remains sealed inside severed compartments 14, 16, 18, 20, 22, 24, 26, 28 because each corresponding strip 90a-h remains attached to surface 48 and occludes the opening 58.

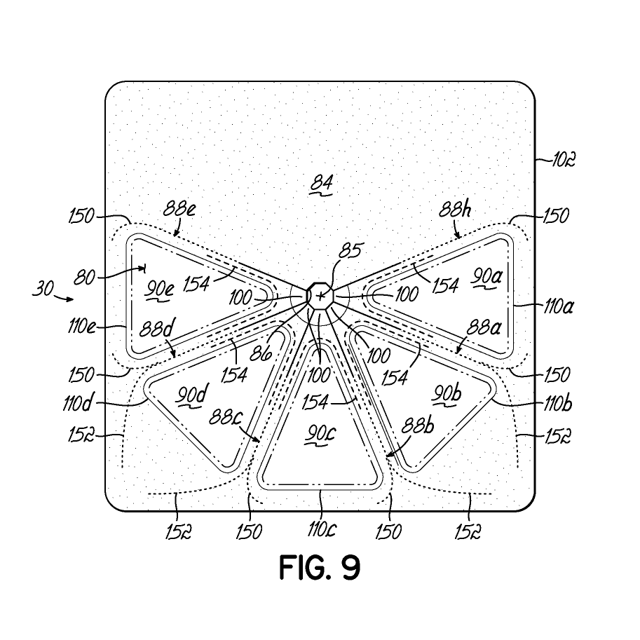

With reference to FIG. 9 in which like reference numerals refer to like features in FIGS. 1-8 and in accordance with an alternative embodiment, the cover 30 may be modified under a circumstance in which fewer than all of the compartments 14, 16, 18, 20, 22, 24, 26, 28. For example, a plurality of the compartments 14, 16, 18, 20, 22, 24, 26, 28 may remain unfilled with oral medications and, in one specific embodiment, an adjacent plurality of the compartments 14, 16, 18, 20, 22, 24, 26, 28 may remain unfilled with oral medications. In this instance, some of the strips 90a-h may be omitted from the construction of the cover 30 and the section of the surface 82 of cover 30 with a surface area overlying the unfilled compartments may be receive printed common information to the packaging 10, such as prescription number, patient name, etc. The information in data field 122 (FIG. 3) would only be printed on only the sections of surface 82 on the remaining strips 90a, 90e-h.

In one more specific embodiment, compartments 24, 26, and 28 may remain unfilled so that each package contains five oral medications 25 and six packages may be distributed to provide a total count of thirty doses. However, if the PRN script is written as “take two when needed” in a different specific embodiment, then twelve packages each containing five oral medications 25 may be distributed to provide a script quantity of sixty doses.

To modify and/or control the tearing characteristics of the strips 90c-g, the slits 94 of the tear lines 88a-h may be extended outwardly toward the outer perimeter 102 of the cover 30. These peripheral extensions 150, 152 of the slits 94 may exhibit non-linear or curvilinear paths on the cover 30, as shown in FIG. 9. Specifically, the curved lines of the curvilinear paths may extend about the underlying corners 62, 64 of the body 12 and may contrast with the linear paths of the tear lines 88a-h. The peripheral extensions 150, 152 may have different lengths constrained by the available space on the cover 30. Additional set of slits 154 may be positioned near the respective tips of the strips 90c-g. In addition, some portions of the tears lines 88a-h may include sets of double perforations.

All or a portion of the tear lines 88a-h may also comprise microperforations, which are a dense arrangement of small perforations with a density as large as one hundred per inch and that are designed to provide a clean tear. Microperforations can be formed, among other ways, by mechanical needle perforation either with or without heating, electrostatic discharge, or laser drilling.

The release liner is die cut, while resident on the cover 30, to define sections of release liner that function as the regions 110a, 110e-h and have locations selectively correlated with the location of the openings 58 to the compartments 14, 16, 18, 20, 22, 24, 26, 28 of the body 12. The release liner may have, for example, a silicone coating that allows easy removal of the cover; however, during removal of the release line to expose the coating 84 for attaching the cover 30 to the body 12, the regions 110a, 110e-h remain attached by the coating 84 to the cover 30. The regions 110a, 110e-h prevent the oral medications 25 from adhering to the coating 84 prior to removal from the compartments 14, 16, 18, 20, 22, 24, 26, 28.

In use and with reference to FIGS. 1-8, one or more of the compartments 14, 16, 18, 20, 22, 24, 26, 28 of the body 12 are filled with the requisite oral medications 25 at a pharmacy or other type of filling facility. Specifically, a single unit dose of the oral medication 25 can be inserted into each of the compartments 14, 16, 18, 20, 22, 24, 26, 28 through the respective opening 58 and reside therein as best shown in FIG. 8. The compartments 14, 16, 18, 20, 22, 24, 26, 28 are filled with the oral medications 25 by either a manual, semi-automated, or automated process. In one embodiment, each oral medication 25 inserted into one of the compartments 14, 16, 18, 20, 22, 24, 26, 28 is a unit dose that is identical to the other unit doses. In an alternative embodiment, one or more of the compartments 14, 16, 18, 20, 22, 24, 26, 28 may contain multiple unit doses of the oral medication 25. It is understood that one or more of the compartments 14, 16, 18, 20, 22, 24, 26, 28 in the body 12 may remain unfilled and empty in the filled and sealed condition of the packaging 10. For example, compartments 14, 16, 18, 20, 22, 24 may be filled and compartments 26, 28 may be unfilled.

After the compartments 14, 16, 18, 20, 22, 24, 26, 28 are populated with the oral medications 25, the cover 30 is attached to the body 12 to form the assembly, as best shown in FIGS. 5 and 6. The attachment (e.g., an adhesive bond) is established by the coating 84 disposed between the surface 48 of the body 12 and the surface 80 of the cover 30. In the sealed condition, the packaging 10 is closed against the entry of environmental contaminants and against the loss of the oral medications 25. In the sealed condition, the compartments 14, 16, 18, 20, 22, 24, 26, 28 are isolated from each other so that the oral medications 25 are confined and segregated to prevent commingling among the different oral medications 25. The isolation of the oral medications 25 contrasts with conventional packages in which the oral medications 25 are not segregated and may commingle together.

The packaging 10 can be transferred from a medication filling facility to another location (e.g., delivered to a patient at the patient's residence or domicile) with the oral medications 25 confined inside the covered compartments 14, 16, 18, 20, 22, 24, 26, 28. The oral medications 25 are stored in each packaging 10 until administered to a patient.

At the location of the patient and in advance of oral consumption, each oral medication 25 can be removed from one of the compartments 14, 16, 18, 20, 22, 24, 26, 28 through the same openings 58 used for filling. To that end, the packaging 10 is made available to a patient for whom the oral medications 25 contained in the packaging 10 were prescribed or to a patient caregiver. The patient or patient caregiver may grasp the packaging 10 in one hand with a finger inserted from below into the space between the compartments 14, 16, 18, 20, 22, 24, 26, 28 of the body 12 and the palm of the hand contacting the exterior surface 69 of at least some of the compartments 14, 16, 18, 20, 22, 24, 26, 28. With the opposite hand, the patient or patient caregiver grips and lifts one of the pull tabs 100 using their finger tips. The patient may use an object to provide assistance in gripping the pull tab 100. The respective slits 92 in the adjacent tear lines 88a-h promotes the lifting of the pull tab 100. In this instance, the pull tab 100 of strip 90a is illustrated as being gripped for manipulating the strip 90a to open compartment 14.

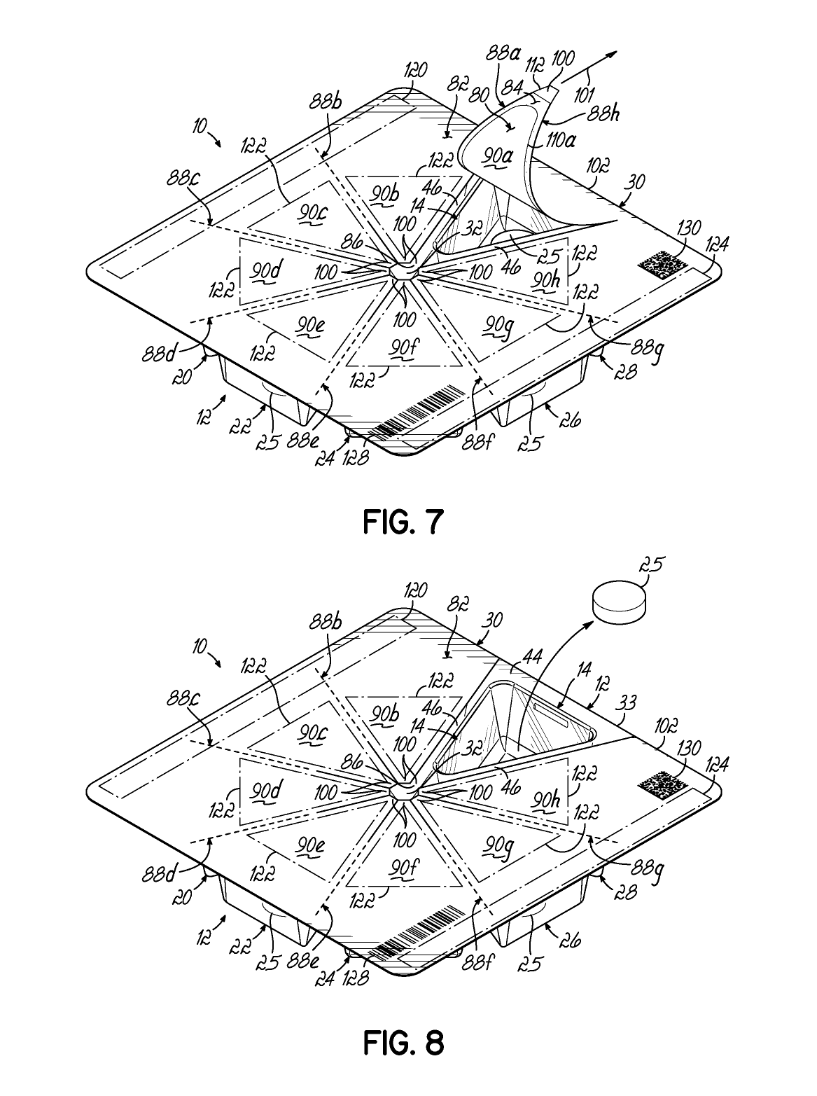

Once lifted, the pull tab 100 of strip 90a can be manipulated by movement relative to the cover 30 in a direction away from the reference point 85 and toward an outer perimeter 102 of the cover 30, which is diagrammatically indicated by the single-headed arrow 101 in FIG. 7. The movement of the pull tab 100 initiates tearing along the tear lines 88a, 88h bordering strip 90a. Tearing propagates along the tear lines 88a, 88h generally along the line of the slits 94. The tearing may deviate from the tear lines 88a, 88h into the interior of the strip 90a as a propagating fracture. The strip 90a is progressively peeled from the body 12 by overcoming the attachment between the body 12 and cover 30 produced by the coating 84. The manipulation of the strip 90a unblocks the opening 58 at the entrance to the compartment 14, as best shown in FIG. 8.

In one embodiment, the body 12 is oriented upright when the strip 90a is removed and the patient or caregiver may then dispense the oral medication 25 by inverting the packaging 10. The oral medication 25 is released from the compartment 14 through the now unblocked opening 58 of compartment 14. The removed oral medication 25 is then administered in a conventional manner to the patient.

The cover strip 90a or a portion of the cover strip 90a may be used as evidence of interaction with the package 10, such as evidence of consumption or engagement with the package 10. For instance, the removed strip 90a or portion of strip 90a may be used or placed into a medication management log or documented on a tracking form as a step to ensure patient compliance.

The oral medications 25 are administered, when needed, from the package 10 to the patient. Additional oral medications 25 are individually dispensed from compartments 16, 18, 20, 22, 24, 26, 28 in a similar manner to that described above in relation to compartment 14. When the packaging 10 is emptied of oral medications 25, the patient or patient caregiver can conveniently dispose of the packaging 10, which is non-reusable.

The packaging 10 may be provided to a patient in a non-institutional (e.g., home or residential) setting. In one embodiment, the patient may be identified while in a transitional care facility, such as a hospital, rehabilitation center, or step-down care unit, and solicited to participate in a home/residence distribution service program following discharge from the transitional care facility. The oral medications 25 are prescribed by the patient's physician(s) and are filled by the service program provider with the oversight of a pharmacist. The service program provider is responsible for packaging the oral medications 25 into the packagings 10 and delivering the packagings 10 to the patient's domicile. In another embodiment, the patient may be solicited by direct advertising, by agreement with an organization to which the patient belongs, by agreement with a company that employs or that once employed the patent, etc.

Alternatively, the packagings 10 may be targeted for use by patients while resident in senior housing, such as assisted living facilities (ALF), skilled nursing facility facilities (SNF), and independent living facilities (ILF). At a skilled nursing facility, acute care and rehabilitation services are provided to each patient. Care is typically not provided to patients living at an independent living facility, which has the appearance of a multifamily setting with common meals, entertainment, and active senior life activities. An independent living facility also has the appearance of a multifamily setting but general assistance is provided for daily life activities.

The packaging 10 may include indicia on the compartments 14, 16, 18, 20, 22, 24 as described in application Ser. No. 13/153,900 and may be packaged in cartons as described in application Ser. No. 13/153,900.

References herein to terms such as “vertical”, “horizontal”, “upper”, “lower”, “raise”, “lower”, etc. are made by way of example, and not by way of limitation, to establish a frame of reference. It is understood by persons of ordinary skill in the art that various other frames of reference may be equivalently employed for purposes of describing the embodiments of the invention.

It will be understood that when an element is described as being “attached”, “connected”, or “coupled” to or with another element, the element can be directly connected or coupled to the other element or, instead, one or more intervening elements may be present. In contrast, when an element is described as being “directly attached”, “directly connected”, or “directly coupled” to another element, there are no intervening elements present. When an element is described as being “indirectly attached”, “indirectly connected”, or “indirectly coupled” to another element, there is at least one intervening element present.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising.”

While the invention has been illustrated by a description of various embodiments and while these embodiments have been described in considerable detail, it is not the intention of the applicants to restrict or in any way limit the scope of the appended claims to such detail. Additional advantages and modifications will readily appear to those skilled in the art. The invention in its broader aspects is therefore not limited to the specific details, representative methods, and illustrative examples shown and described. Accordingly, departures may be made from such details without departing from the spirit or scope of applicants' general inventive concept.

What is claimed is:

1. A packaging for holding a plurality of dosage units, the packaging comprising:
a body including a plurality of compartments each configured to hold at least one of the dosage units, the compartments having a circular arrangement relative to a reference point on the body; and
a cover including a plurality of strips attached to the body for confining the dosage units in the compartments, each of the strips positioned relative to a respective one of the compartments and configured to be individually manipulated for releasing the dosage unit from the respective one of the compartments.

2. The packaging of claim 1 wherein the strips are arranged as sectors of a circle that spatially coincide with the circular arrangement of the compartments.

3. The packaging of claim 1 wherein the cover includes a first surface that is attached to the body and a second surface between the first surface and the compartments, and further comprising:
a data field on the first surface, the data field comprised of human-readable text.

4. The packaging of claim 3 wherein the data field is on a portion of the first surface associated with one of the strips.

5. The packaging of claim 1 wherein the cover includes a plurality of tear lines, each of the strips defined by an adjacent pair of the tear lines.

6. The packaging of claim 5 wherein the cover includes a first surface that is attached to the body, a second surface between the first surface and the compartments, and an opening extending through the cover from the first surface to the second surface, and the tear lines intersect the opening.

7. The packaging of claim 6 wherein the opening is generally circular, the cover has an outer perimeter, the tear lines extend radially from an edge of the opening toward the outer perimeter, and a separation between adjacent pairs of the tear lines increases with increasing distance from the edge of the opening.

8. The packaging of claim 6 wherein a portion of each strip proximate to the opening defines a pull tab.

9. The packaging of claim 5 wherein each tear line includes a plurality of slits that have a linear alignment relative to each other.

10. The packaging of claim 9 wherein the plurality of slits includes a plurality of first slits and a second slit that is longer than the first slits.

11. The packaging of claim 10 wherein the first slits and the second slit are collinearly aligned.

12. The packaging of claim 10 wherein the cover includes a first surface that is attached to the body, a second surface between the first surface and the compartments, and an opening extending through the cover from the first surface to the second surface, and the second slit of each tear line intersects the opening.

13. The packaging of claim 5 wherein each of the compartments has a first side wall and a second side wall joined to the first side wall at a first corner, the first and second sidewalls disposed between an adjacent pair of the tear lines.

14. The packaging of claim 5 wherein the body includes a plurality of tear lines, each compartment disposed between an adjacent pair of tear lines in the body, and each tear line in the body is generally aligned with one of the tear lines in the cover.

15. The packaging of claim 1 wherein the compartments and the strips are numerically equal.

16. An assembly comprising the packaging of claim 1 and the dosage units.

17. The assembly of claim 16 wherein each of the dosage units comprises a single unit dose.

18. The assembly of claim 16 wherein the dosage units are comprised of the same ingestible substance.

19. The assembly of claim 18 wherein the dosage units comprise a single type of oral medication.

20. A method of administering a plurality of dosage units from a packaging having a body with a plurality of compartments and a cover attached to the body, the cover divided into a plurality of strips each confining at least one of the dosage units in one of the compartments, the method comprising:
manipulating one of the strips to unblock an opening to one of the compartments; and
removing the dosage unit from the compartment through the unblocked opening.

21. The method of claim 20 wherein manipulating one of the strips to unblock the opening to one of the compartments comprises:
tearing along tear lines bordering the strip to manipulate the strip and unblock the opening.

22. The method of claim 21 wherein manipulating one of the strips to unblock the opening to one of the compartments further comprises:
lifting a pull tab; and
moving the pull tab relative to the cover to manipulate the one of the strips and initiate the tearing along the tear lines.

23. The method of claim 20 wherein manipulating one of the strips to unblock the opening to one of the compartments comprises:
progressively peeling the strip from the body in a direction toward an outer perimeter of the cover.

24. The method of claim 20 wherein the direction of the progressive peeling is from proximate to a center of the cover toward the outer perimeter of the cover.

25. The method of claim 20 further comprising:
manipulating another of the strips to unblock an opening to another of the compartments; and
removing the dosage unit from the compartment through the unblocked opening.

26. The method of claim 20 further comprising:
removing the strip from the cover; and
using the strip to evidence an interaction with the packaging.
